(19) United States
(12) Patent Application Publication
(10) Pub. No.: US 2010/0318560 A1
(43) Pub. Date: Dec. 16, 2010

(54) SEARCH PROCESSOR AND SEARCH PROCESSING METHOD

(75) Inventor: Koichi Morishita, Komae-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/782,340

(22) Filed: May 18, 2010

(30) Foreign Application Priority Data
Jun. 16, 2009 (JP) 2009-143665

(51) Int. Cl. G06F 17/30

(52) U.S. Cl. 707/769; 707/E17.014

(57) ABSTRACT

A search processor for performing search processes by comparing data registered in a database with a search key includes a search database in which data to be searched for is registered and that outputs the registered data according to an input address. The processor further includes a search segment database in which address segment information and bit segment information are registered. It outputs the registered information, the address segment information indicating address segmentation in the search database and the bit segment information indicating bit-position segmentation in the search database. A search address used in the search database is generated based on the address segment information. The bit position of data registered at that search address is then converted based on the bit segment information, and the converted data is compared with the search key so as to output comparison results.

### BACKGROUND OF THE INVENTION

1. Field of the Invention

The present invention relates to search technology using content addressable memory, and in particular to a technique for managing memory in search segments.

2. Description of the Related Art

In network protocol processing, search processes are performed based on databases called tables. There are multiple representative examples of such search processes including ARP table searches, socket table searches, TCPCB searches, and routing table searches, and the cost of such searches is considerable. For this reason, systems that perform searches using dedicated hardware called search engines (or dedicated processors) are known. One known device used in such search engines is a dedicated memory device that is called content addressable memory (CAM). CAM is a special type of memory which, upon receipt of a search key, outputs addresses where registration data that matches the search key is stored. CAM allows extremely high-speed searches because it is capable of simultaneously outputting all memory cells that store registration data and comparing the data with the search key.

As described above, there are multiple search objects in network protocol processing, so if CAM is provided for each search objects mentioned previously, the circuit size will increase. To solve this problem, a search processor is proposed that is capable of performing searches corresponding to multiple protocols with a single CAM (see Japanese Patent Laid-Open No. 8-212790).

In the above-described conventional example, since the protocol address format varies from protocol to protocol, data of the same format is not always stored in the same segment at each entry. Thus, the first segment is fully searched by the initial search process so as to extract only entries that store a protocol to be searched for and define them as search objects, which allows multiple protocol tables to be mounted on a single CAM, thus reducing the number of CAMs.

However, entries to be searched for are selected by protocol identifiers, so that although a single CAM is capable of storing search data of multiple protocols, the CAM mounted has a length equivalent to the maximum protocol address, and those bits that are unnecessary for other protocols are not used. This wastes bits of high cost CAM.

As described above, the conventional problem is the waste of databases used for searches.

### SUMMARY OF THE INVENTION

The present invention provides an apparatus and method that allow highly flexible searches while reducing the waste of databases.

According to one aspect of the present invention, there is provided a search processor for performing a search process by comparing data registered in a database with a search key, comprising: a search database in which data to be searched for is registered and that outputs the registered data according to an input address; a search segment database in which address segment information and bit segment information are registered and that outputs the registered information, the address segment information indicating address segmentation in the search database and the bit segment information indicating bit-position segmentation in the search database; and a comparison unit that compares data in the data registered in the search database with the search key and outputs a comparison result, the compared data being registered in an address range specified by the address segment information and in a bit range specified by the bit segment information.

According to another aspect of the present invention, there is provided a search processing method used in a search processor for performing a search process by comparing data registered in a database with a search key, comprising: reading data from a search database in which data to be searched for is registered, the read data being registered in an address range specified by address segment information that indicates address segmentation in the search database; and comparing data in the read data with the search key and outputting a comparison result, the compared data being registered in a bit range specified by bit segment information that indicates bit-position segmentation in the search database in which data to be searched for is registered.

Further features of the present invention will become apparent from the following description of exemplary embodiments (with reference to the attached drawings).

### BRIEF DESCRIPTION OF THE DRAWINGS

FIG. 1 illustrates an example hardware configuration that implements a search processing method according to a first embodiment.

FIG. 2 illustrates an example configuration of a search database.

FIG. 3 illustrates an example configuration of a search segment database.

FIG. 4 illustrates an example configuration of a comparator.

FIG. 5 illustrates, in time-series, search processes with the search database according to the first embodiment.

FIG. 6 illustrates an example hardware configuration that implements a search processing method according to a second embodiment.

FIG. 7 illustrates an example segment array in the search database.

FIG. 8 illustrates an example configuration of a search segment database according to the second embodiment.

FIG. 9 illustrates, in time series, search processes with the search database according to the second embodiment.

### DESCRIPTION OF THE EMBODIMENTS

Hereinafter, embodiments of the present invention will be described in detail with reference to the drawings. The present embodiments describe apparatuses and methods that perform searches by comparing data registered in a search database constituted by dedicated memory of what is called content addressable memory (CAM) with an input search key.

### First Embodiment

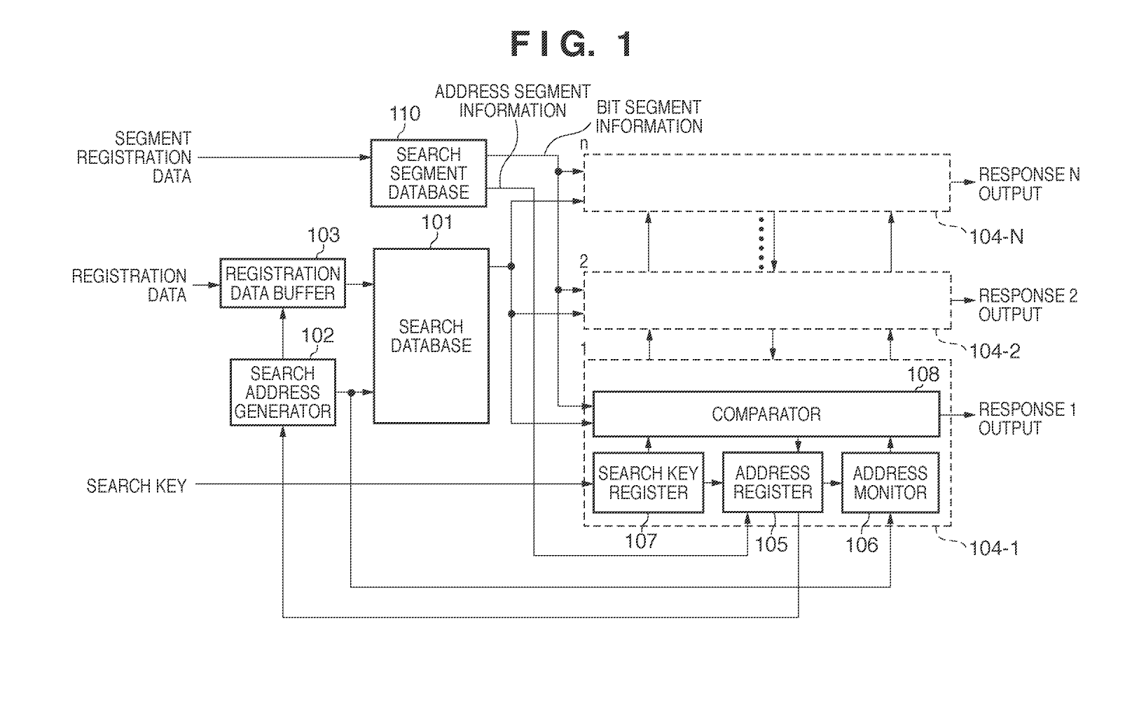

First, a search processing method for dividing space in a search database according to segment information and performing searches on search objects that differ from segment to segment will be described as a first embodiment with reference to FIGS. 1 to 5.

FIG. 1 illustrates an example hardware configuration that implements the search processing method according to the first embodiment. In FIG. 1, a search database 101 is constituted by memory such as SRAM. A search address generator 102 generates a search address used for searching the search database 101. A registration data buffer 103 temporarily accumulates data to be registered in the search database 101. In a search segment database 110, search segment information on the search database 101 is registered. Multiple comparison search devices 104 are each constituted by an address register 105, an address monitor 106, a search key register 107, and a comparator 108.

The address register 105 holds an address to be compared and searched for, based on address information received from the search address generator 102 and address segment information stored in the search database 101. The address monitor 106 monitors the address in the search address generator 102. The search key register 107 holds data to be searched for based on search keys and search types. The comparator 108 compares data stored at the address held in the address register 105 in the search database 101 and data held in the search key register 107, according to bit segment information from the search segment database 110.

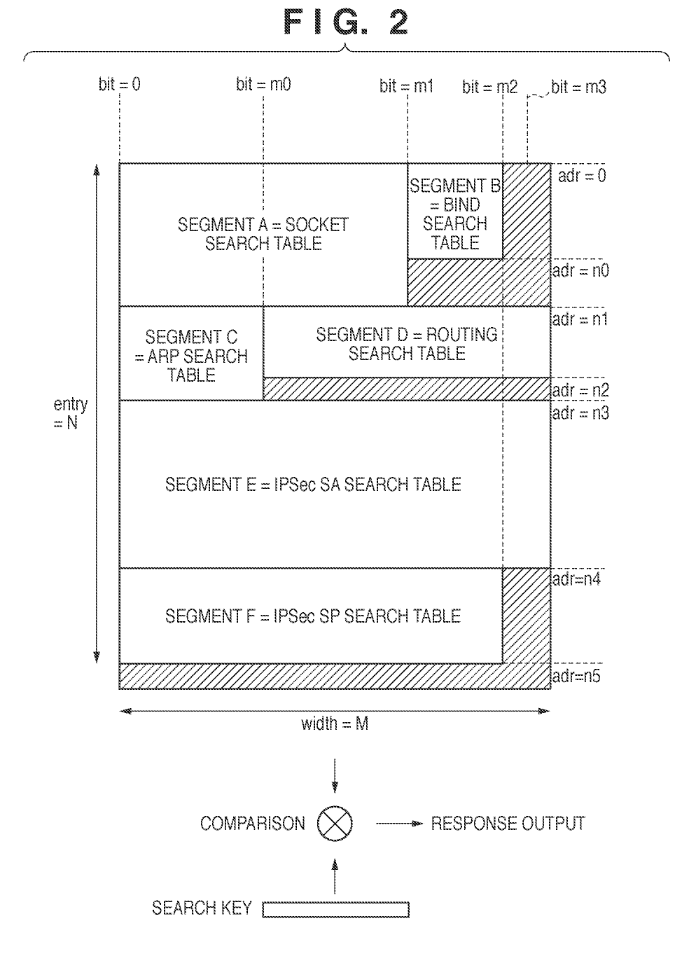

Here, an example configuration of the search database 101 will be described with reference to FIG. 2. Note that, in network protocol processing, there are multiple search processes including, for example, ARP table searches, socket table searches, and routing table searches, and the width of the search key and the depth of the search entry vary depending on search objects.

As illustrated in FIG. 2, it is normal for the bit width required for a single search and the amount of data registered in a table to vary depending on search types, and the locations of addresses where tables are stored to vary. The first embodiment is described based on the example configuration of the search database illustrated in FIG. 2.

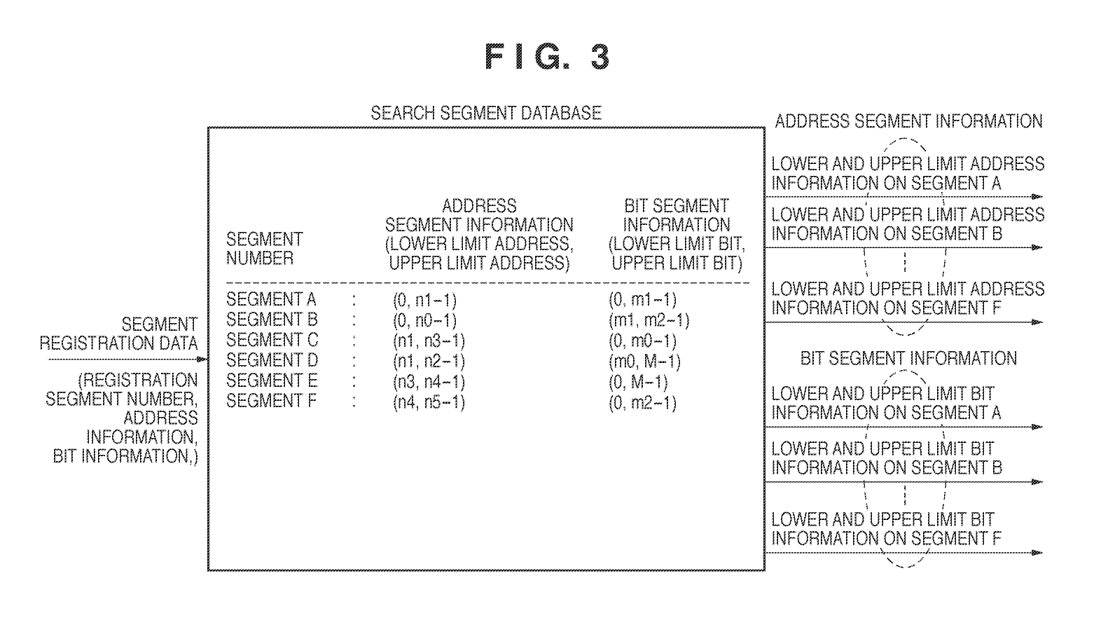

In the case where the search database 101 is configured as illustrated in FIG. 2, address segment information (lower and upper limit addresses) and bit segment information (lower and upper limit bits), as illustrated in FIG. 3, are registered for each segment in the search segment database 110. As illustrated in FIG. 2, addresses 0 to N are assigned from top to bottom to the search database 101. Each address is capable of holding M-bit data. In other words, the search database 101 is capable of storing N pieces of M-bit data. For example, in the case of a segment A (socket search table), the lower limit address is “0”, the upper limit address is “n1-1,” the lower limit bit is “0,” and the upper limit bit is “m1-1”. That is, the socket search table has n pieces of m1-bit socket information registered therein. From among data stored at addresses from 0 to n1-1, the data from the 0th bit to the (m1-1)th bit is socket information. The other segments are also similarly set in correspondence with search data on the search database 101. Information on each segment is output from the search segment database 110.

Next, basic search processes according to the first embodiment will be described. First, when a search key and a search type are input into the search key register 107 of the comparison search device 104, it is determined whether or not the search type output from the search segment database 110 matches the search type input from an external device. If they match based on the result of the determination, a starting address, an ending address, a loopback source address, and a loopback destination address are stored in the address register 105 according to the address information output from the search address generator 102. The address register 105 is constituted by a starting address register, an ending address register, a loopback source address register, and a loopback destination address register. Then, the addresses are notified from the address register 105 to the address monitor 106.

Specifically, in cases where other searches within the same entry are not performed, the lower and upper limit addresses output from the search segment database 110 are stored respectively into the start and ending address registers in the address register 105. In this case, no data is stored in the loopback source address register and the loopback destination address register. In cases where another search within the same entry is performed, the current address that is currently being generated by the search address generator 102 is stored into the starting address register in the address register 105, and a value equal to the current address minus one is stored into the ending address register. The upper limit address output from the search segment database 110 is stored into the loopback source address register, and the lower limit address output from the search segment database 110 is stored into the loopback destination address register. As a result, from among the data registered in the search database 101, the data registered in the address range specified by the address segment information (lower and upper limit addresses) is determined as a search object. Further details of this will be described later.

The address monitor 106 gives an instruction to start to generate a search address when it detects that the search address generator 102 is not generating an address. Thus, addresses are continuously given from the search address generator 102 to the search database 101, starting from the starting address to the ending address. That is, data registered in the address range specified by the lower and upper limit addresses is read from the search database 101. Registration data corresponding to the address is output from the search database 101 and compared with the search key by the comparator 108. At this time, the comparison is performed only on the data registered within the bit width specified by the bit segment information (lower and upper limit bits) output from the search database 101. That is, data in the read data that is in the bit range specified by the bit segment information is compared with the search key. If they match based on the result of the comparison, the matched information is output as a response output.

As described above, the comparator 108 compares data that is registered in the address range specified by the address segment information and in the bit range specified by the bit segment information with the search key and outputs comparison results. Here, in cases where a single response output is required for a single search input, this search process is ended, whereas in cases where multiple response outputs are required for a single search input, the search addresses continue to be generated. This search process is ended at the time when the output up to the ending address from the search database 101 is complete.

As illustrated in FIG. 2, for example, a socket search table and a BIND search table are allocated at addresses from 0 to n0-1, which indicates that different search segments of data are allowed to be allocated at the same address in the search database 101. With such a configuration, the allocated data is searched for, for each search segment, based on information indicating search segments of search objects.

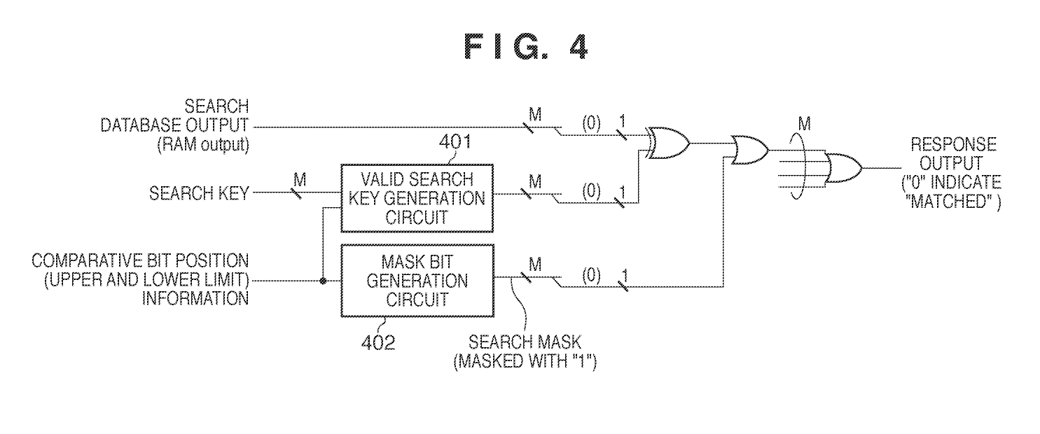

Now, an example configuration of the comparator 108 in a comparison search device 104 will be described with reference to FIG. 4. The comparator 108 is configured to perform M-bit wide comparison as illustrated in FIG. 4 and perform comparison and masking for each bit. Here, M bits match the bit width M of the search database 101. A valid search key generation circuit 401 converts an input search key so as to fit into a valid bit position according to comparative bit (lower and upper limit bit) information from the search segment database 110. For example, when the lower limit bit is “32” and the upper limit bit is “63,” the search key is shifted to positions ranging from the 32th to 63th bits. Here, assume that the input search key is aligned to the 0th bit of the M-bit search key.

A mask-bit generation circuit 402 generates a mask signal for each bit from the comparative bit (lower and upper limit bit) information. For example, when the lower limit bit is “32” and the upper limit bit is “63,” the 32th to 63th bits are set to “0” and the other bits are all output as “1”. Then, a comparison is made for each bit based on the signals generated by the valid search key generation circuit 401 and the mask bit generation circuit 402, and ultimately, all the bits are ORed to generate a search response (matched/mismatched) signal.

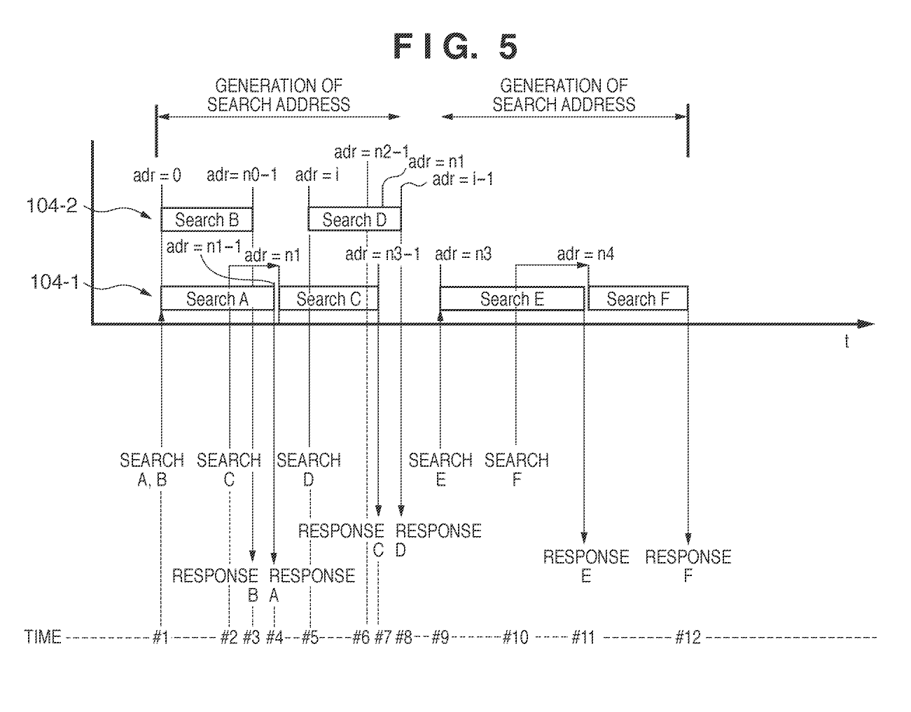

Next, search processes performed in the search database 101 will be described with reference to FIG. 5. The vertical axis indicates the operating status of each comparison search device 104, and the horizontal axis indicates time. Note that, while two comparison search devices 104-1 and 104-2 are mounted in the example illustrated in FIG. 5, the number of comparison search devices to be mounted is not limited thereto.

First, upon input of requests for “Search A” and “Search B” at time #1, the comparison search device 104-1 starts “Search A” (socket search) and the comparison search device 104-2 starts “Search B” (BIND search). At this time, neither of the two comparison search devices 104-1 and 104-2 are running. Thus, the comparison search device 104-1 stores “0” and “n1-1” respectively into the starting address register and the ending address register in the address register 105, based on address segment information (upper and lower limit addresses) on segment A that is output from the search segment database. Similarly, the comparison search device 104-2 stores “0” and “n0-1” respectively into the starting address register and the ending address register in the address register 105, based on address segment information (upper and lower limit addresses) on segment B that is output from the search segment database. Here, no data is stored in the loopback source address registers and the loopback destination address registers.

In addition, the type of required search results, either “single-hit” or “multiple-hit,” is selected in advance. A single-hit search refers to a search method in which the search is ended at the time when the same data that matches the search key is found in the search database 101, so this search obtains only one search result. On the other hand, a multiple-hit search refers to a search method in which a given search scope of the search database 101 is searched so as to output multiple search results. The following description is based on the premise that all searches are multiple-hit searches. Thus, as many searches as the number of preset entries are always performed irrespective of search results.

At time #3 (at address n0-1), “Search B” that has a smaller number of entries is first complete and response B is output. At this time, “Search A” is ongoing and thus the address continues to be incremented. Later at time #4 when the address reaches n1-1, “Search A” is complete and response A is returned. At time #2 during the execution of “Search A” and “Search B,” a request for “Search C” (ARP search) is input. In the present example, only the two comparison search devices 104 are mounted, so “Search C” is left pending until “Search A” and “Search B” are complete.

Then, the searches by the comparison search devices 104-1 and 104-2 are complete at times #3 and #4, which allows the start of the pending “Search C” at time #4. The starting address at this time is n1, and the ending address is n3-1. At time #5, a new request for “Search D” (routing search) is input, at which time one of the comparison search devices 104-2 is available and thus “Search D” is started immediately. The lower limit address of “Search D” output from the search segment database 110 is n1. In this case, the current address i that is currently being output from the search address generator 102 is higher than this lower limit address, so the current address i is stored into the starting address register for “Search D” and i-1 is stored into the ending address register. At the same time, n2-1 and n1 are stored respectively into the loopback source address register and the loopback destination address register.

The basic operation is such that the address jumps to the loopback destination address when it reaches the loopback source address, and then it is incremented therefrom up to the ending address. This allows comparison to be started at a particular point in the segment, thus improving search responsiveness.

At time #6, the address in the search address generator 102 reaches n2-1, that is, the loopback source address of “Search D”. However, since the ending address of “Search C” is n3-1, the address is not able to jump to n1, which is the loopback destination address of “Search D”. The address thus continues to be generated up to n3-1, which is the ending address of “Search C”.

At time #7, “Search C” is complete and response C is output. At this time, the address jumps to the loopback destination address n1 of “Search D,” from which the search continues until response D is output at time #8. Also, assume that the comparison is controlled not to be performed during the interval between times #6 to #7, because the address is out of the comparison range of “Search D”.

From time #8, the two comparison search devices 104-1 and 104-2 are both available, but a search address is not generated because there is no search request. This time interval may be used to update the search database 101 and the search segment database 110.

At time #9, a search request for “Search E” (IPSec SA search) is input and “Search E” is started immediately, which continues until time #11. At time #10 during this time interval, a request for searching a search segment F (IPSec SP search) is input. However, since the search segments E and F are allocated in completely different address areas (one from n3 to n4-1 and the other from n4 to n5-1), searches with multiple comparison search devices are not feasible. Thus, “Search F” is started immediately at time #11 when “Search E” is complete. Ultimately, “Search F” is complete at time #12.

While the first embodiment has described the example of mounting two comparison search devices, the number of comparison search devices may be increased so as to allow simultaneous searches of more segments stored at the same address. On the contrary, only a single comparison search device may be provided in order to reduce the mounting cost. In this case, the cost is reduced, although search throughput is degraded because of the incapability of performing simultaneous comparison on multiple comparative objects.

Moreover, in the first embodiment, while the six search objects are set in the search database, the present invention is, of course, not limited thereto. In addition, while a maximum of two search objects are stored at the same address in the present embodiment, the number of search objects is, or course, not limited thereto.

Still moreover, while the description of the first embodiment is based on the premise that all searches are multiple-hit searches, some searches may be single-hit searches depending on search objects. In this case, comparison does not always need to be performed up to the upper limit address, and it may be regarded that the segment search is completed at the time of a single hit.

According to the first embodiment, providing the search segment database that corresponds to the search database and performing a search of a different search object for each segment inhibit increases in the number of memory devices and capacity, thus making available a low cost and highly flexible data search processor.

### Second Embodiment

Next, a second embodiment according to the present invention will be described in detail with reference to the drawings. In the first embodiment, a different search object is allocated in each segment and a search process is performed for each segment, whereas the second embodiment describes an example application based on the basic concept of the invention.

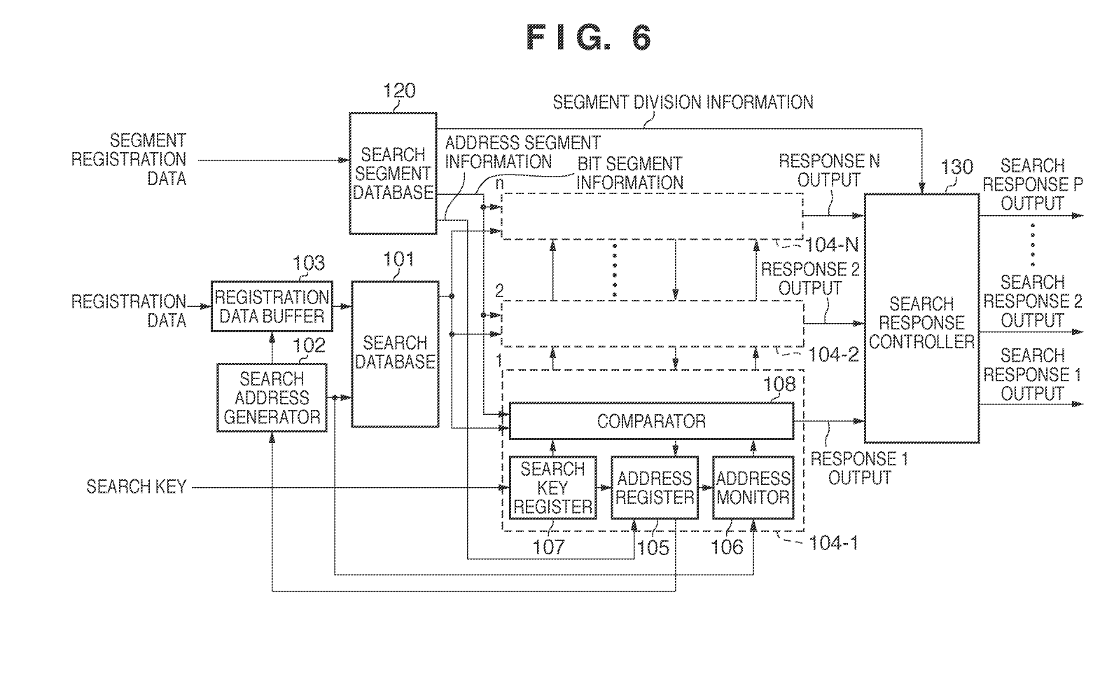

FIG. 6 illustrates an example hardware configuration that implements a search processing method according to the second embodiment. What are different from the first embodiment in FIG. 1 are the addition of segment division information to the output of a search segment database 120 and the addition of a search response controller 130.

The search response controller 130 receives response outputs from comparison search devices 104 and segment division information that is output from the search segment database 120, and outputs a search response for each search object. The response outputs that are input into the search response controller 130 are only response outputs obtained from respective comparison searches, and the response output from the search response controller 130 is the final search response output obtained by combining segment responses of divided segments.

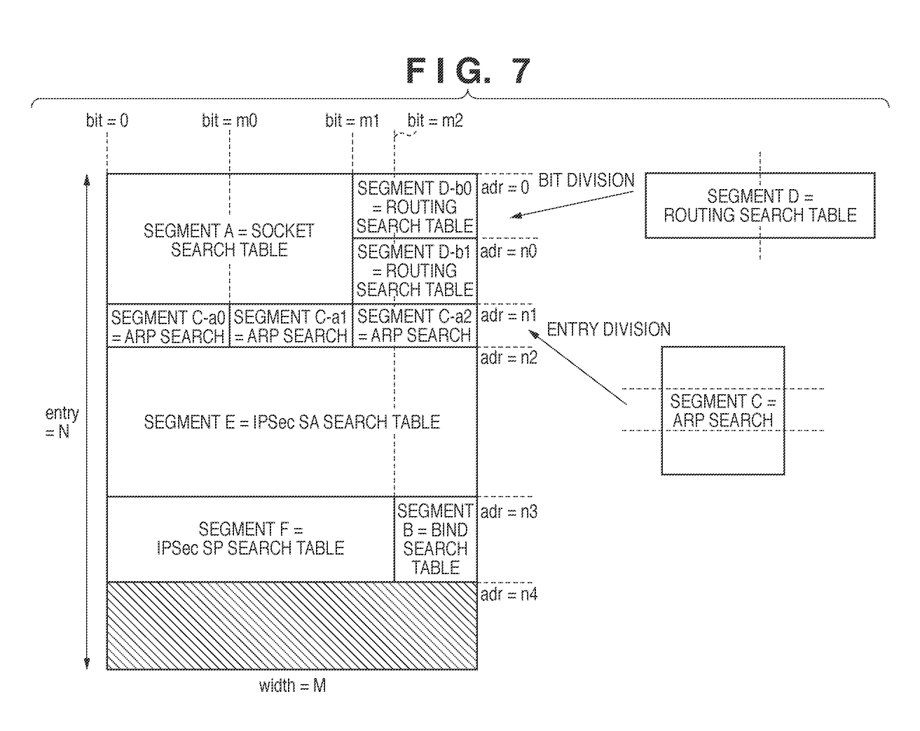

FIG. 7 illustrates an example segment array in a search database 101. A routing search table is divided into two segments D-b0 and D-b1 and allocated beside a socket search table. This routing search table is obtained by dividing the routing table in the first embodiment (FIG. 2) along the bit direction and allocated as the two segments D-b0 and D-b1. Also, an ARP search table is divided into and allocated as three segments C-a0, C-a1, and C-a2. This table is obtained by dividing the ARP search table of the first embodiment into three segments along the entry (address) direction.

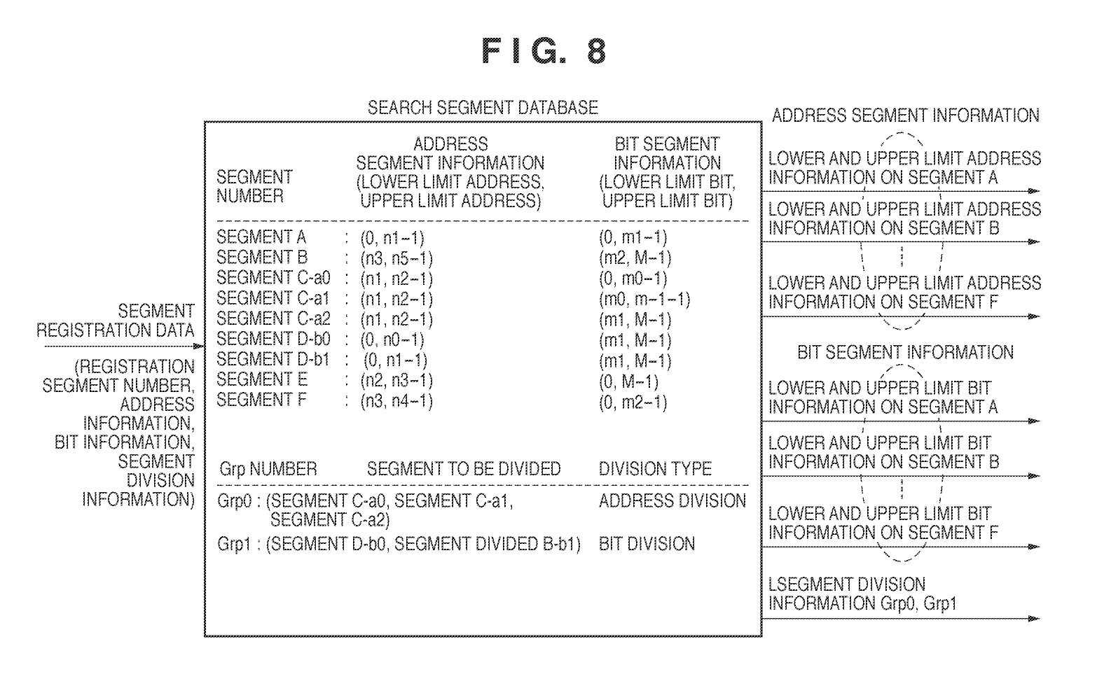

FIG. 8 illustrates an example configuration of the search segment database 120 corresponding to the search database 101 illustrated in FIG. 7. As in the first embodiment, the segment information registers coordinate information on RAM for each segment. For the segments C and D divided and allocated in the search database 101, the coordinates after the division are set. In addition to this, segment division information is registered. This information indicates all segment numbers after division and their division types. For example, in the case of the ARP search table that is divided into the segments C-a0, C-a1, and C-a2, its division type is “address division” (Grp0). Similarly, in the case of the routing search table that is grouped into the segments D-b0 and D-b1, its division type is “bit division” (Grp1). Such division types are output from the search segment table 120.

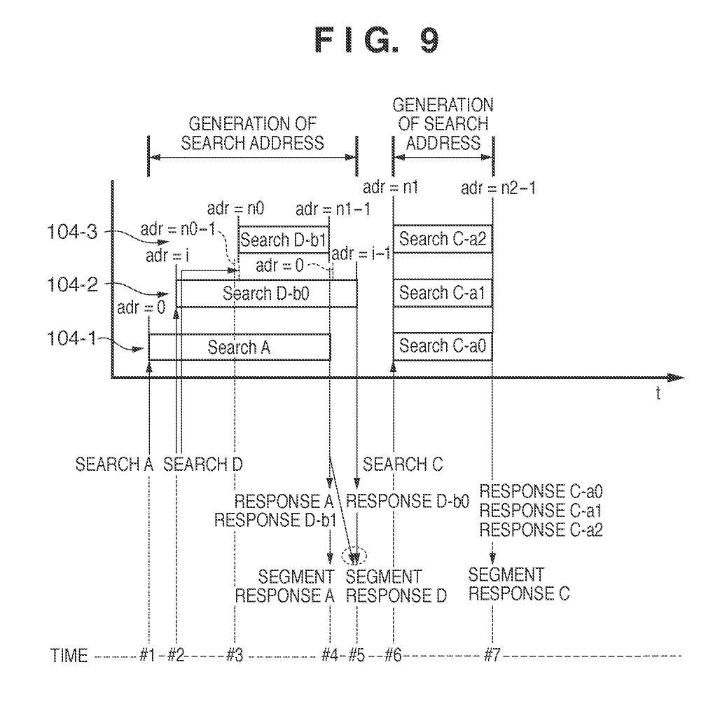

Here, search processes according to the second embodiment will be described with reference to FIG. 9. In the example illustrated in FIG. 9, it is assumed that three comparison search devices 104-1 to 104-3 are mounted and search data is stored in search segments as illustrated in FIGS. 7 and 8.

First, upon input of a request for “Search A” at time #1, the lower limit address “0” and the upper limit address “n1-1” of “Search A” are stored respectively into the starting address register and the ending address register in the address register 105 of a comparison search device 104-1, and “Search A” is started. At time #2, a request for “Search D” is input and “Search D-b0” of the search segment D-b0 is started with an available comparison search device 104-2. Since the search segment D-b1 is outside the current address under execution, the start of its search process is left pending.

At time #3, the search address reaches the address n0-1 that is the upper limit address of the search segment D-b0. At this time, since the search of the search segment A continues, the address still continues to be incremented. From here, the comparison operation of the comparison search device 104-2 becomes redundant. Simultaneously with this, the starting address and the ending address of the search segment D-b1 are set and the comparison operation of the segment is started. At time #4, the search address reaches the upper limit address n1-1 of the search segments A and D-b1, and responses A and D-b1 are output. Those responses are only the responses of the respective comparison search devices 104 and they are not the responses of the socket search unit and the routing search unit that are being searched. Meanwhile, since the search segment A is not grouped with other search segments, the search result of the search segment A is output directly as segment response A. Segment response D is not yet output because the search of the segment D-b0 has not yet been completed. Moreover, when the address reaches the upper limit address n1-1, the address generation for the comparison search device 104-2 whose comparison operation is pending is restarted. The address jumps from n1-1 to 0, from which the search is continued.

At time #5, the search process of the comparison search device 104-2 is complete and response D-b0 is output. Here, the responses of the divided segments D-b0 and D-b1 are complete and final segment response D is output. As illustrated in the search segment database 120 in FIG. 8, the responses D-b0 and D-b1 are of the bit division type, so the comparison results presented by the responses D-b0 and D-b1 are ANDed to obtain final search results.

Then, at time #6, another search is started upon a request for “Search C”. Since all segments for “Search C” are included in the same entries, the three comparison search devices 104-1 to 104-3 simultaneously perform comparison operations. The searches are started after setting n1 and n2-1 respectively to the starting address registers and the ending address register of the comparison search devices 104-1 to 104-3. Then, at time #7, the three search processes are complete and their responses are output to the search response controller 130. Here, since the division type of “Search C” is “address division,” its responses are ORed to generate final segment response C.

As in the case of “Search C,” if the search table is divided into three by address and allocated along the bit direction and the three comparison search devices 104-1 to 104-3 are used, three times as much search responsiveness is feasible. Also, as in the case of “Search D,” if the search table is divided into two by bit and allocated along the address direction, the effective use of the RAM area is feasible, although search responsibility is degraded by one half. Similarly, in the case of “Search C,” even if there is only a single comparison search device, the effective use of the RAM area is feasible, although search responsiveness is degraded.

While the second embodiment has described the example where the search segments C and D illustrated in FIG. 7 are allocated close to each other, the present invention is not limited thereto, and such segments may be allocated at distant addresses or in distant bits. In this case, it is apparent that, although search responsibility might be degraded, locally available RAM spaces may be possibly combined together so as to generate a single search target table.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-143665, filed Jun. 16, 2009, which is hereby incorporated by reference herein in its entirety.

What is claimed is:

1. A search processor for performing a search process by comparing data registered in a database with a search key, comprising:
a search database in which data to be searched for is registered and that outputs the registered data according to an input address;
a search segment database in which address segment information and bit segment information are registered and that outputs the registered information, the address segment information indicating address segmentation in the search database and the bit segment information indicating bit-position segmentation in the search database; and
a comparison unit that compares data in the data registered in the search database with the search key and outputs a comparison result, the compared data being registered in an address range specified by the address segment information and in a bit range specified by the bit segment information.

2. The search processor according to claim 1, wherein
the search database has data of different search segments arranged at the same address, and
for each of the search segments, the arranged data is searched for based on information indicating the search segments.

3. The search processor according to claim 1, wherein the search processor includes at least two comparison units for simultaneously performing a plurality of searches that fall within the same search segment.

4. A search processing method used in a search processor for performing a search process by comparing data registered in a database with a search key, comprising:
reading data from a search database in which data to be searched for is registered, the read data being registered in an address range specified by address segment information that indicates address segmentation in the search database; and
comparing data in the read data with the search key and outputting a comparison result, the compared data being registered in a bit range specified by bit segment information that indicates bit-position segmentation in the search database in which data to be searched for is registered.

5. A computer-readable recording medium storing a program for causing a computer to perform the search processing method according to claim 4.
